(19) United States
(12) Patent Application Publication
(10) Pub. No.: US 2007/0044064 A1
(43) Pub. Date: Feb. 22, 2007

(54) Processor network

(76) Inventors: Andrew Duller, Bristol (GB); Singh Panesar, Bristol (GB); Alan Gray, Bath (GB); Peter John Claydon, Bath (AU); William Philip Robbins, Bristol (GB)

Correspondence Address: POTOMAC PATENT GROUP, PLLC, P. O. BOX 270, FREDERICKSBURG, VA, 22404, US

(21) Appl. No.: 10/546,615

(22) PCT Filed: Feb. 19, 2004
(86) PCT No.: PCT/GB04/00670

§ 371 Date: Oct. 26, 2006

(30) Foreign Application Priority Data
Feb. 21, 2003 (GB) 0304056.5

(51) Int. Cl. G06F 17/50

(52) U.S. Cl. 716/17

(57) ABSTRACT

Processes are automatically allocated to processors in a processor array, and corresponding communications resources are assigned at compile time, using information provided by the programmer. The processing tasks in the array are therefore allocated in such a way that the resources required to communicate data between the different processors are guaranteed.

This invention relates to a processor network, and in particular to an array of processors having software tasks allocated thereto. In other aspects, the invention relates to a method and a software product for automatically allocating software tasks to processors in an array.

Processor systems can be categorised as follows:

Single Instruction, Single Data (SISD). This is a conventional system containing a single processor that is controlled by an instruction stream.

Single Instruction, Multiple Data (SIMD), sometimes known as an array processor, because each instruction causes the same operation to be performed in parallel on multiple data elements. This type of processor is often used for matrix calculations and in supercomputers.

Multiple Instruction, Multiple Data (MIMD). This type of system can be thought of as multiple independent processors, each performing different instructions on the same data.

MIMD processors can be divided into a number of sub-classes, including:

Superscalar, where a single program or instruction stream is split into groups of instructions that are not dependent on each other by the processor hardware at run time. These groups of instructions are processed at the same time in separate execution units. This type of processor only executes one instruction stream at a time, and so is really just an enhanced SISD machine.

Very Long Instruction Word (VLIW). Like superscalar, a VLIW machine has multiple execution units executing a single instruction stream, but in this case the instructions are parallelised by a compiler and assembled into long words, with all instructions in the same word being executed in parallel. VLIW machines may contain anything from two to about twenty execution units, but the ability of compilers to make efficient use of these execution units falls off rapidly with anything more than two or three of them.

Multi-threaded. In essence these may be superscalar or VLIW, with different execution units executing different threads of program, which are independent of each other except for defined points of communication, where the threads are synchronized. Although the threads can be parts of separate programs, they all share common memory, which limits the number of execution units.

Shared memory. Here, a number of conventional processors communicate via a shared area of memory. This may either be genuine multi-port memory, or processors may arbitrate for use of the shared memory. Processors usually also have local memory. Each processor executes genuinely independent streams of instructions, and where they need to communicate information this is performed using various well-established protocols such as sockets. By its nature, inter-processor communication in shared memory architectures is relatively slow, although large amounts of data may be transferred on each communication event.

Networked processors. These communicate in much the same way as shared-memory processors, except that communication is via a network. Communication is even slower and is usually performed using standard communications protocols.

Most of these MIMD multi-processor architectures are characterised by relatively slow inter-processor communications and/or limited inter-processor communications bandwidth when there are more than a few processors. Superscalar, VLIW and multi-threaded architectures are limited because all the execution units share common memory, and usually common registers within the execution units; shared memory architectures are limited because, if all the processors in a system are able to communicate with each other, they must all share the limited bandwidth to the common area of memory.

For network processors, the speed and bandwidth of communication is determined by the type of network. If data can only be sent from a processor to one other processor at one time, then the overall bandwidth is limited, but there are many other topologies that include the use of switches, routers, point-to-point links between individual processors and switch fabrics.

Regardless of the type of multiprocessor system, if the processors form part of a single system, rather than just independently working on separate tasks and sharing some of the same resources, the various parts of the overall software task must be allocated to different processors. Methods of doing this include:

Using one or more supervisory processors that allocate tasks to the other processors at run time. This can work well if the tasks to be allocated take a relatively long time to complete, but can be very difficult in real time systems that must perform a number of asynchronous tasks.

Manually allocating processes to processors. By its nature, this usually needs to be done at compile time. For many real time applications this is often preferred, as the programmer can ensure that there are always enough resources available for the real time tasks. However, with large numbers of processes and processors the task becomes difficult, especially when the software is modified and processes need to be reallocated.

Automatically allocating processes to processors at compile time. This has the same advantages as manual allocation for real time systems, with the additional advantage of greatly reduced design time and ease of maintenance for systems that include large numbers of processes and processors.

The present invention is concerned with allocation of processes to processors at compile time.

As processor clock speeds increase and architectures become more sophisticated, each processor can accomplish many more tasks in a given time period. This means that tasks can be performed on processors that required special-purpose hardware in the past. This has enabled new classes of problem to be addressed, but has created some new problems in real time processing.

Real time processing is defined as processing where results are required by a particular time, and is used in a huge range of applications from washing machines, through automotive engine controls and digital entertainment systems, to base stations for mobile communications. In this latter application, a single base station may perform complex signal processing and control for hundreds of voice and data calls at one time, a task that may require hundreds of processors. In such real time systems, the jobs of scheduling tasks to be run on the individual processors at specific times, and arbitrating for use of shared resources, have become increasingly difficult. The scheduling issue has arisen in part because individual processors are capable of running tens or even hundreds of different processes, but, whereas some of these processes occur all the time at regular intervals, others are asynchronous and may only occur every few minutes or hours. If tasks are scheduled incorrectly, then a comparatively rare sequence of events can lead to failure of the system. Moreover, because the events are rare, it is a practical impossibility to verify the correct operation of the system in all circumstances.

One solution to this problem is to use a larger number of smaller, simpler processors and allocate a small number of fixed tasks to each processor. Each individual processor is cheap, so it is possible for some to be dedicated to servicing fairly rare, asynchronous tasks that need to be completed in a short period of time. However, the use of many small processors compounds the problem of arbitration, and in particular arbitration for shared bus or network resources. One way of overcoming this is to use a bus structure and associated programming methodology that guarantees that the required bus resources are available for each communication path. One such structure is described in WO02/50624.

In one aspect, the present invention relates to a method of automatically allocating processes to processors and assigning communications resources at compile time using information provided by the programmer. In another aspect, the invention relates to a processor array, having processes allocated to processors.

More specifically, the invention relates to a method of allocating processing tasks in multi-processor systems in such a way that the resources required to communicate data between the different processors are guaranteed. The invention is described in relation to a processor array of the general type described in WO02/50624, but it is applicable to any multi-processor system that allows the allocation of slots on the buses that are used to communicate data between processors.

For a better understanding of the present invention, reference will now be made by way of example to the accompanying drawings, in which:

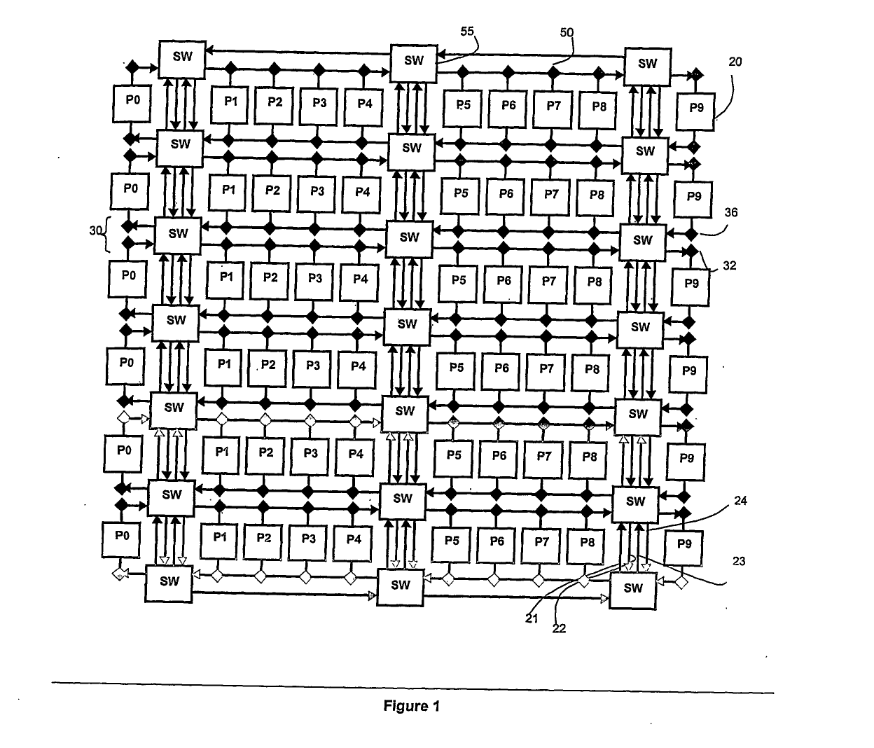

FIG. 1 is a block schematic diagram of a processor array in accordance with the present invention.

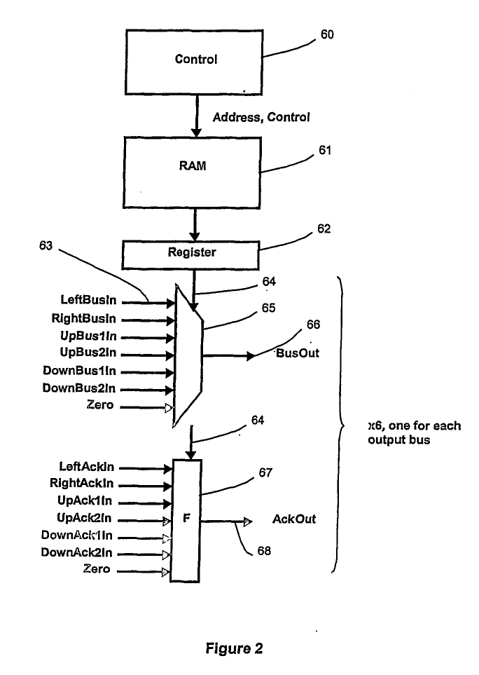

FIG. 2 is an enlarged block schematic diagram of a part of the processor array of FIG. 1.

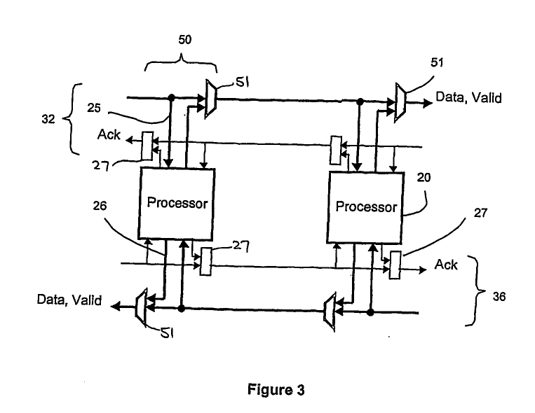

FIG. 3 is an enlarged block schematic diagram of another part of the processor array of FIG. 1.

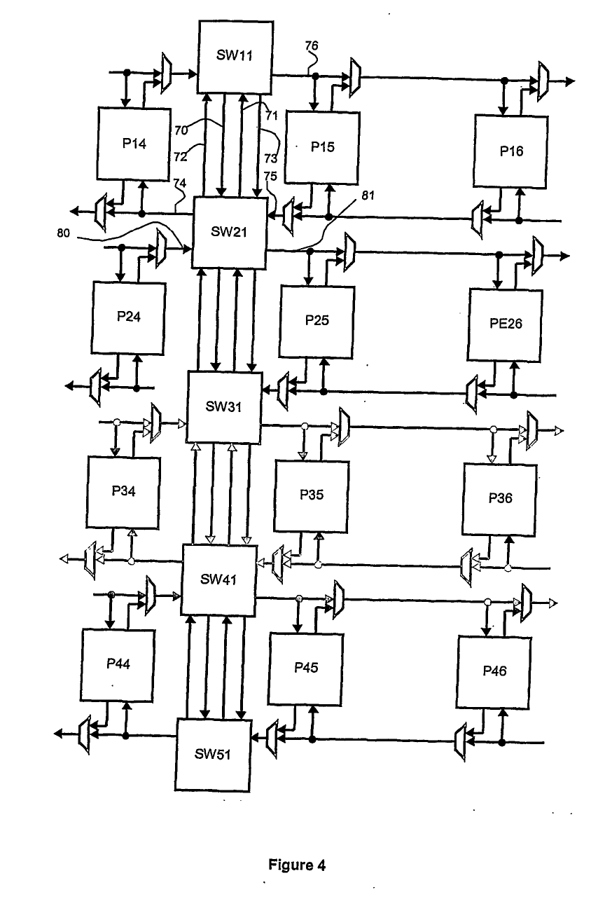

FIG. 4 is an enlarged block schematic diagram of a further part of the processor array of FIG. 1.

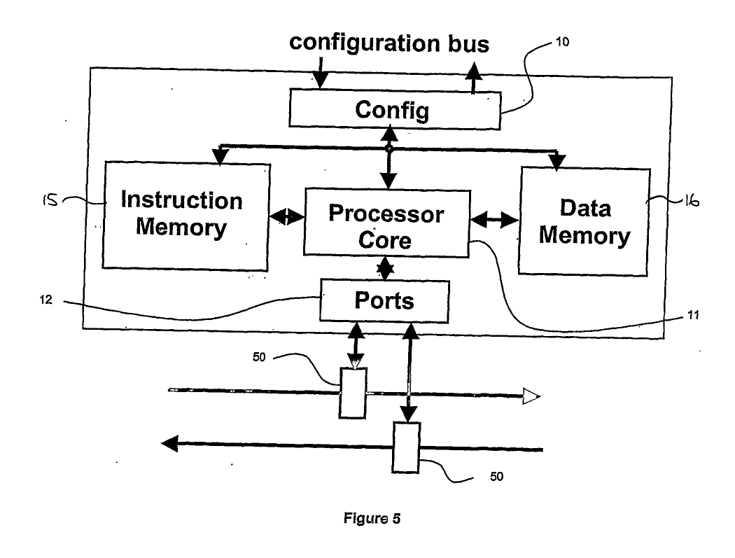

FIG. 5 is an enlarged block schematic diagram of a further part of the processor array of FIG. 1.

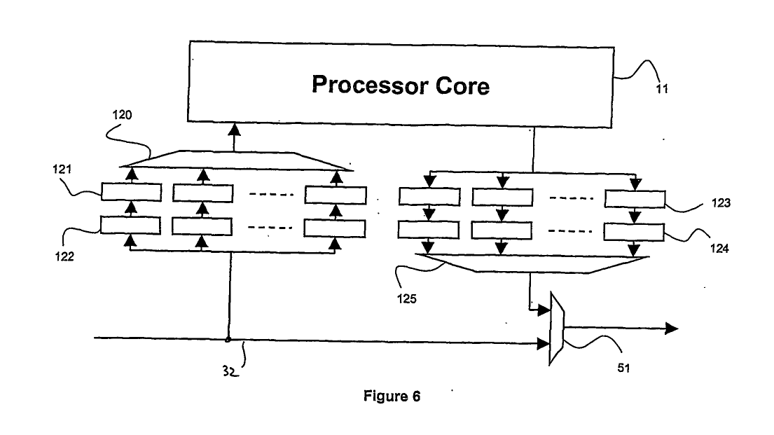

FIG. 6 is an enlarged block schematic diagram of a still further part of the processor array of FIG. 1.

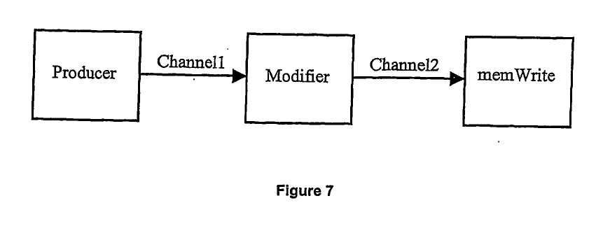

FIG. 7 illustrates a process operating on the processor array of FIG. 1.

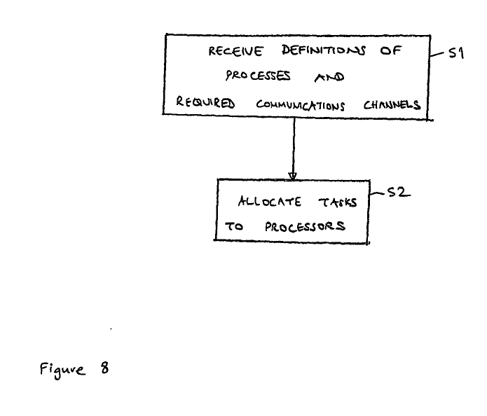

FIG. 8 is a flow chart illustrating a method in accordance with the present invention.

Referring to FIG. 1, a processor array of the general type described in WO02/50624 consists of a plurality of processors 20, arranged in a matrix. FIG. 1 shows six rows, each consisting of ten processors, with the processors in each row numbered P0, P1, P2, . . . , P8, P9, giving a total of 60 processors in the array. This is sufficient to illustrate the operation of the invention, although one preferred embodiment of the invention has over 400 processors. Each processor 20 is connected to a segment of a horizontal bus running from left to right, 32, and a segment of a horizontal bus running from right to left, 36, by means of connectors, 50. These horizontal bus segments 32, 36 are connected to vertical bus segments 21, 23 running upwards and vertical bus segments 22, 24 running downwards at switches 55, as shown.

Although FIG. 1 shows one form of processor array in which the present invention may be used, it should be noted that the invention is also applicable to other forms of processor array.

Each bus in FIG. 1 consists of a plurality of data lines, typically 32 or 64, a data valid signal line and two acknowledge signal lines, namely an acknowledge signal and a resend acknowledge signal.

The structure of each of the switches 55 is illustrated with reference to FIG. 2. The switch 55 includes a RAM 61, which is pre-loaded with data. The switch further includes a controller 60, which contains a counter that counts through the addresses of the RAM 61 in a pre-determined sequence. This same sequence is repeated indefinitely, and the time taken to complete the sequence, measured in cycles of the system clock, is referred to as the sequence period. On each clock cycle, the output data from RAM 61 is loaded into a register 62.

The switch 55 has six output buses, namely the respective left to right horizontal bus, the right to left horizontal bus, the two upwards vertical bus segments, and the two downwards vertical bus segments, but the connections to only one of these output buses are shown in FIG. 2 for clarity. Each of the six output buses consists of a bus segment 66 (which consists of the 32 or 64 line data bus and the data valid signal line), plus lines 68 for output acknowledge and resend acknowledge signals.

A multiplexer 65 has seven inputs, namely from the respective left to right horizontal bus, the right to left horizontal bus, the two upwards vertical bus segments, the two downwards vertical bus segments, and from a constant zero source. The multiplexer 65 has a control input 64 from the register 62. Depending on the content of the register 62, the data on a selected one of these inputs during that cycle is passed to the output line 66. The constant zero input is preferably selected when the output bus is not being used, so that power is not used to alter the value on the bus unnecessarily.

At the same time, the value from the register 62 is also supplied to a block 67, which receives acknowledge and resend acknowledge signals from the respective left to right horizontal bus, the right to left horizontal bus, the two upwards vertical bus segments, the two downwards vertical bus segments, and from a constant zero source, and selects a pair of output acknowledge signals on line 68.

FIG. 3 is an enlarged block schematic diagram showing how two of the processors 20 are connected to segments of the left to right horizontal bus 32 and the right to left horizontal bus 36 at respective connectors 50. A segment of the bus, defined as the portion between two multiplexers 51, is connected to an input of a processor by a connection 25. An output of a processor is connected to a segment of the bus through an output bus segment 26 and another multiplexer 51. In addition, acknowledge signals from processors are combined with other acknowledge signals on the buses in acknowledge combining blocks 27.

The select inputs of multiplexers 51 and blocks 27 are under control of circuitry within the associated processor.

All communication within the array takes place in a predetermined sequence. In one embodiment, the sequence period is 1024 clock cycles. Each switch and each processor contains a counter that counts for the sequence period. On each cycle of this sequence, each switch selects one of its input buses onto each of its six output buses. At predetermined cycles in the sequence, processors load data from their input bus segments via connection 25, and switch data onto their output bus segments using the multiplexers, 51.

As a minimum, each processor must be capable of controlling its associated multiplexers and acknowledge combining blocks, loading data from the bus segments to which it is connected at the correct times in sequence, and performing some useful function on the data, even if this only consists of storing the data.

The method by which data is communicated between processors will be described by way of example with reference to FIG. 4, which shows a part of the array in FIG. 1, in which a processor in row “x” and column “y” is identified as Pxy.

For the purposes of illustration, a situation will be described in which data is to be sent from processor P24 to processor P15. At a predefined clock cycle, the sending processor P24 enables the data onto bus segment 80, switch SW21 switches this data onto bus segment 72, switch SW11 switches it onto bus segment 76 and the receiving processor P15 loads the data.

Communications paths can be established between other processors in the array at the same time, provided that they do not use any of the bus segments 80, 72 or 76. In this preferred embodiment of the invention, the sending processor P24 and the receiving processor P15 are programmed to perform one or a small number of specific tasks one or more times during a sequence period. As a result, it may be necessary to establish a communications path between the sending processor P24 and the receiving processor P15 multiple times per sequence period.

More specifically, the preferred embodiment of the invention allows the communications path to be established once every 2, 4, 8, 16, or any power of two up to 1024, clock cycles.

At clock cycles when the communications path between the sending processor P24 and the receiving processor P15 is not established, the bus segments 80, 72 and 76 may be used as part of a communications path between any other pair of processors.

Each processor in the array can communicate with any other processor, although it is desirable for processes to be allocated to the processors in such a way that each processor communicates most frequently with its near neighbours, in order to reduce the number of bus segments used during each transfer.

In the preferred embodiment of the invention, each processor has the overall structure shown in FIG. 5. The processor core 11 is connected to instruction memory 15 and data memory 16, and also to a configuration bus interface 10, which is used for configuration and monitoring, and to input/output ports 12, which are connected through bus connectors 50 to the respective buses, as described above.

The ports 12 are structured as shown in FIG. 6. For clarity, this shows only the ports connected to the respective left to right bus 32, and not those connected to the respective right to left bus 36, and does not show control or timing details. Each communications channel for sending data between a processor and one or more other processor is allocated a pair of buffers, namely an input pair 121, 122 for an input port or an output pair 123, 124 for an output port. The input ports are connected to the processor core 11 via a multiplexer 120, and the output ports are connected to the array bus 32 via a multiplexer 125 and a multiplexer 51.

For one processor to send data to another, the sending processor core executes an instruction that transfers the data to an output port buffer, 124. If there is already data in the buffer 124 that is allocated to that communications channel, then the data is transferred to buffer 123, and if buffer 123 is also occupied then the processor core is stopped until a buffer becomes available. More buffers can be used for each communications channel, but it will be shown below that two is sufficient for the applications being considered. On the cycle allocated to the particular communications channel (the “slot”), data is multiplexed onto the array bus segment using multiplexers 125 and 51 and routed to the destination processor or processors as described above.

In a receiving processor, the data is loaded into a buffer 121 or 122 that has been allocated to that channel. The processor core 11 on the receiving processor can then execute instructions that transfer data from the ports via the multiplexer 120. When data is received, if both buffers 121 and 122 that are allocated to the communication channel are empty, then the data word will be put in buffer 121. If buffer 121 is already occupied, then the data word will be put in buffer 122. The following paragraphs illustrate what happens if both buffers 121 and 122 are occupied.

It will be apparent from the above description that, although slots for the transfer of data from processor to processor are allocated on a regular cyclical basis, the presence of the buffers in the output and input ports means that the processor core can transfer data to and from the ports at any time, provided it does not cause the output buffers to overflow or the input buffers to underflow. This is illustrated in the example in the table below, where the column headings have the following meanings:

Cycle. For the purposes of this example, each system clock cycle has been numbered.

PUT. The transfer of data from the processor core to an output port is termed a “PUT”. In the table, an entry appears in the PUT column whenever the sending processor core transfers data to the output port. The entry shows the data value that is transferred. As outlined above, the PUT is asynchronous to the transfer of data between processors; the timing is determined by the software running on the processor core.

OBuffer0. The contents of output buffer 0 in the sending processor (the output buffer 124 connected to the multiplexer 125 in FIG. 6).

OBuffer1. The contents of output buffer 1 in the sending processor (the output buffer 123 connected to the processor core 11 in FIG. 6).

Slot. Indicates cycles during which data is transferred. In this example, data is transferred every four cycles. The slots are numbered for clarity.

IBuffer0. The contents of input buffer 0 in the receiving processor (the input buffer 121 connected to the processor core 120 in FIG. 6).

IBuffer1. The contents of input buffer 1 in the receiving processor (the input buffer 122 connected to the bus 32 in FIG. 6).

GET. The transfer of data from an input port to the processor is termed a “GET”. In the table, an entry appears in the GET column whenever the receiving processor transfers data from the input port. The entry shows the data value that is transferred. As outlined above, the GET is asynchronous to the transfer of data between processors; the timing is determined by the software running on the processor core.

| Cycle | PUT | OBuffer1 | OBuffer0 | Slot | IBuffer1 | IBuffer0 | GET |
|---|---|---|---|---|---|---|---|
| 0 | | | | | | | |
| 1 | D0 | | D0 | | | | |
| 2 | | | D0 | | | | |
| 3 | | | D0 | 1 | | | |
| 4 | | | | | | D0 | |
| 5 | D1 | | D1 | | | D0 | |
| 6 | D2 | D2 | D1 | | | D0 | |
| 7 | | D2 | D1 | 2 | | D0 | |
| 8 | | | D2 | | D1 | D0 | |
| 9 | | | D2 | | | D1 | D0 |
| 10 | | | D2 | | | D1 | |
| 11 | | | D2 | 3 | D2 | D1 | |
| 12 | | | | | D2 | D1 | |
| 13 | | | | | | D2 | D1 |
| 14 | | | | | | D2 | |
| 15 | | | | 4 | | D2 | |
| 16 | | | | | | D2 | |
| 17 | | | | | | | D2 |
| 18 | | | | | | | |

This invention preferably uses a method of writing software in manner that can be used to program the processors in a multi-processor system, such as the one described above. In particular, it provides a method of capturing a programmer's intentions concerning communications bandwidth requirements between processors and using this to assign bus resources to ensure deterministic communications. This will be explained by means of an example.

An example program is given below, and is represented diagrammatically in FIG. 7. In the example, the software that runs on the processors is written in assembler so that the operations of PUT to and GET from the ports can clearly be seen. This assembly code is in the lines between the keywords CODE and ENDCODE in the architecture descriptions of each process. The description of how the channels carry data between processes is written in the Hardware Description Language, VHDL (IEEE Std 1076-1993). FIG. 7 illustrates how the three processes of Producer, Modifier and memWrite are linked by channel 1 and channel 2.

Most of the details of the VHDL and assembler code are not material to the present invention, and anyone skilled in the art will be able to interpret them. The material points are:

Each process, defined by a VHDL entity declaration that defines its interface and a VHDL architecture declaration that defines its contents, is by some means, either manually or by use of an automatic computer program, placed onto processors in the system, such as the array in FIG. 1.

For each channel, the software writer has defined a slot frequency requirement by using an extension to the VHDL language. This is the “@” notation, which appears in the port definitions of the entity declarations and the signal declarations in the architecture of “toplevel”, which defines how the three processes are joined together.

The number after the “@” signifies how often a slot must be allocated between the processors in the system that are running the processes, in units of system clock periods. Thus, in this example, a slot will be allocated for the Producer processes to send data to the Modifier process along channel 1 (which is an integer16pair, indicating that the 32-bit bus carries two 16 bit values) every 16 system clock periods, and a slot will be allocated for the Modifier process to send data to the memWrite process every 8 system clock periods.

entity Producer is
port (outPort:out integer16pair@16);

end entity Producer;

architecture ASM of Producer is

```
begin STAN
initialize regs:= (0,0,0,0,0,0,0,0,0,0,0,0,0,0,0);
  CODE
    loop
        for r6 in 0 to 9 loop
            copy.0 r6,r4
            add.0 r4, 1, r5
            put r[5:4], outport
            end loop
        end loop
      ENDCODE;
  end Producer;
  entity Modifier is
    port (outPort:out integer16pair@8;
            inPort:in  integer16pair@16);
  end entity Modifier;
  architecture ASM of Modifier is
  begin MAC
  initialize regs:= (0,0,0,0,0,0,0,0,0,0,0,0,0,0,0);
    CODE
        loop
          for r6 in 10 to 19 loop
              get inport, r[3:2]
              add.0 r2, 10, r4
              add.0 r3, 10, r5
          put r[5:4], outport --This output should be
input into third AE
          end loop
      end loop
    ENDCODE;
end Modifier;
entity memWrite is
  port (inPort:in integer16pair@8);
end entity memWrite;
architecture ASM of memWrite is
begin MEM
initialize regs:= (0,0,0,0,0,0,0,0,0,0,0,0,0,0,0);
initialize code_partition := 2;
      CODE
      copy.0 0, AP  //initialize write pointer
      loop
          get inPort, r[3:2]
          stl r[3:2], (AP) \ add.0 AP, 4, AP
      end loop
    ENDCODE;
end;
entity toplevel is
end toplevel;
architecture STRUCTURAL of toplevel is
  signal channel1: integer16pair@16;
  signal channel2: integer16pair@8;
begin
    finalObject: entity memWrite
          port map (inPort =>channel2);
    modifierObject: entity Modifier
          port map (inPort=>channel1, outPort=>channel2);
    producerObject: entity Producer
          port map (outPort=>channel1);
end toplevel;
```

As described above, the code between the keywords CODE and ENDCODE in the architecture description of each process is assembled into machine instructions and loaded into the instruction memory of the processor (FIG. 5), so that the processor core executes these instructions. Each time a PUT instruction is executed, data is transferred from registers in the processor core into an output port, as described above, and each time a GET instruction is executed, data is transferred from an input port into registers in the processor core.

The slot rate for each signal, being the number after the “@” symbol in the example, is used to allocate slots on the array buses at the appropriate frequency. For example, where the slot rate is “@4”, a slot must be allocated on all the bus segments between the sending processor and the receiving processors for one clock cycle out of every four system clock cycles; where the slot rate is “@8”, a slot must be allocated on all the bus segments between the sending processor and the receiving processors for one clock cycle out of every eight system clock cycles, and so on.

Using the methods outlined above, software processes can be allocated to individual processors, and slots can be allocated on the array buses to provide the channels to transfer data. Specifically, the system allows the user to specify how often a communications channel must be established between two processors which are together performing a process, and the software tasks making up the process can then be allocated to specific processors in such a way that the required establishment of the channel is possible.

This allocation can be carried out either manually or, preferably, using a computer program.

FIG. 8 is a flow chart illustrating the general structure of a method in accordance with this aspect of the invention.

In step S1, the user defines the required functionality of the overall system, by defining the processes which are to be performed, and the frequency with which there need to be established communications channels between processors performing parts of a process.

In step S2, a compile process takes place, and software tasks are allocated to the processors of the array on a static basis. This allocation is performed in such a way that the required communications channels can be established at the required frequencies.

Suitable software for performing the compilation can be written by a person skilled in the art on the basis of this description and a knowledge of the specific system parameters.

After the software tasks have been allocated, the appropriate software can be loaded onto the respective processors to perform the defined processes.

Using the method described above, a programmer specifies a slot frequency, but not the precise time at which data is to be transferred (the phase or offset). This greatly simplifies the task of writing software. It is also a general objective that no processor in a system has to wait because buffers in either the input or output port of a channel are full. This can be achieved using two buffers in the input ports associated with each channel and two buffers in the corresponding output port, provided that a sending processor does not attempt to execute a PUT instruction more often than the slot rate and a receiving processor does not attempt to execute a GET instruction more often than the slot rate.

There are therefore described a processor array, and a method of allocating software tasks to the processors in the array, which allow efficient use of the available resources.

1. A method of automatically allocating software tasks to processors in a processor array, wherein the processor array comprises a plurality of processors having connections which allow each processor to be connected to each other processor as required, the method comprising:
receiving definitions of a plurality of processes, at least some of said processes being shared processes including at least first and second tasks to be performed in first and second unspecified processors respectively, each shared process being further defined by a frequency at which data must be transferred between the first and second processors; and the method further comprising:
automatically statically allocating the software tasks of the plurality of processes to processors in the processor array, and allocating connections between the processors performing said tasks in each of said respective shared processes at the respective defined frequencies.

2. A method as claimed in claim 1, wherein the method is performed at compile time.

3. A method as claimed in claim 1, comprising performing said step of allocating the software tasks by means of a computer program.

4. A method as claimed in claim 1, further comprising loading software to perform the allocated software tasks onto the respective processors.

5. A computer software product, which, in operation performs the steps of:
receiving definitions of a plurality of processes, at least some of said processes being shared processes including at least first and second tasks to be performed in first and second unspecified processors of a processor array respectively, each shared process being further defined by a frequency at which data must be transferred between the first and second processors; and
statically allocating the software tasks of the plurality of processes to processors in the processor array, and allocating connections between the processors performing said tasks in each of said respective shared processes at the respective defined frequencies.

6. A processor array, comprising a plurality of processors having connections which allow each processor to be connected to each other processor as required, and having an associated software product for automatically allocating software tasks to processors in the processor array, the software product being adapted to:
receive definitions of a plurality of processes, each process being defined by at least first and second tasks to be performed in first and second unspecified processors respectively, each process being further defined by a frequency at which data must be transferred between the first and second processors; and to:
automatically allocate the software tasks of the plurality of processes to processors in the processor array, and allocate connections between the processors performing each of said tasks at the respective defined frequencies.

7. A processor array, comprising;
a plurality of processors,
wherein the processors are interconnected by a plurality of buses and switches which allow each processor to be connected to each other processor as required,
wherein each processor is programmed to perform a respective statically allocated sequence of operations, said sequence being repeated in a plurality of sequence periods,
wherein at least some processes performed in the array involve respective first and second software tasks to be performed in respective first and second processors, and
wherein, for each of said processes, required connections between the processors performing said tasks are allocated at fixed times during each sequence period.

8. A method as claimed in claim 1, wherein the frequency at which data must be transferred is defined as a fraction of the available clock cycles.

9. A method as claimed in claim 8, wherein the frequency at which data must be transferred can be defined as a fraction ½ⁿ of the available clock cycles, for any value of n such that 2≦2ⁿ≦s, where s is the number of clock cycles in a sequence period.
